(19) United States
(12) Patent Application Publication
(10) Pub. No.: US 2020/0123042 A1
(43) Pub. Date: Apr. 23, 2020

(54) OXYNITRIDE GLASS, ITS USE, AND METHODS OF MAKING

(71) Applicant: LIFEPORT, LLC F/K/A LIFEPORT, INC., Woodland, WA (US)

(72) Inventors: William M. Carty, Alfred Station, NY (US); Stephen G. DiPietro, Mont Vernon, NH (US); Hyojin Lee, Alfred, NY (US)

(21) Appl. No.: 16/165,936

(22) Filed: Oct. 19, 2018

(51) Int. Cl. C03C 3/11; C03C 13/00; C03B 5/08; C03B 5/43

(52) U.S. Cl. CPC C03C 3/111; C03C 13/00; C03C 2213/00; C03B 5/43; C03B 5/08

(57) ABSTRACT

A transparent oxynitride glass that includes aluminum, calcium, magnesium, silicon, oxygen, and nitrogen, wherein the aluminum may be provided by an aluminum source comprising about 1 wt % to about 100 wt % aluminum nitride (AlN), based on the total weight of aluminum in the oxynitride glass and/or the nitrogen may be provided by an aluminum source comprising about 1 wt % to about 100 wt % aluminum nitride (AlN), based on the total weight of nitrogen in the oxynitride glass. The oxynitride glass may be substantially free of carbon. Also provided are uses of and articles comprising the oxynitride glass and methods of making the oxynitride glass.

### FIELD

The present field of technology is generally related to oxynitride glass, articles containing the oxynitride glass, and methods for their use and making. More specifically, the present field of technology is related to transparent articles with high impact and/or scratch resistance.

### SUMMARY

In some implementations, an oxynitride glass is provided that includes aluminum, calcium, magnesium, silicon, oxygen, and nitrogen, wherein the aluminum may be provided by an aluminum source comprising about 1 wt % to about 100 wt % aluminum nitride (AlN), based on the total weight of aluminum in the oxynitride glass. In any of the embodiments, the oxynitride glass may be transparent. In any of the embodiments, the oxynitride glass may be substantially free of carbon. In any of the embodiments, the oxynitride glass may have a Vickers hardness of≥about 6.5 GPa.

In some implementations, an oxynitride glass is provided that includes aluminum, calcium, magnesium, silicon, oxygen, and nitrogen, wherein the nitrogen is provided by a nitrogen source comprising about 1 wt % to about 100 wt % aluminum nitride (AlN), based on the total weight of nitrogen in the oxynitride glass. In any of the embodiments, the oxynitride glass may be transparent. In any of the embodiments, the oxynitride glass may be substantially free of carbon. In any of the embodiments, the oxynitride glass may have a Vickers hardness of>about 6.5 GPa.

In any of the embodiments, the oxynitride glass may include about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen.

In another aspect, articles that may include the oxynitride glass described herein are provided. Nonlimiting examples of such articles include windows, screens, optical lens, protective glasses, scanner glasses, glass fibers, or a combination of two or more thereof. In any of the embodiments, the articles may be armor and/or ballistic resistant.

In some other aspects, methods may be provided for making the oxynitride glass described herein. Methods may include: mixing an aluminum source, calcium source, magnesium source, silicon source, nitrogen source, and oxygen source; heating the aluminum source, calcium source, magnesium source, silicon source, nitrogen source, and oxygen source to form a molten oxynitride glass; and cooling the molten oxynitride glass. The oxynitride glass may include aluminum, calcium, magnesium, silicon, oxygen, and nitrogen. In any of the embodiments, the aluminum source may include about 1 wt % to about 100 wt % aluminum nitride (AlN), based on the total weight of the aluminum source. In any of the embodiments, the nitrogen source may include about 1 wt % to about 100 wt % aluminum nitride (AlN), based on the total weight of the nitrogen source. In any of the embodiments, the oxynitride glass may be substantially free of carbon.

In some other aspects, a composition may be provided that includes an aluminum source, a calcium source, a magnesium source, a silicon source, a nitrogen source, and an oxygen source. In any of the embodiments, the aluminum source may include about 1 wt % to about 100 wt % aluminum nitride (AlN), based on the total weight of aluminum in the composition. In any of the embodiments, the nitrogen source may include about 1 wt % to about 100 wt % aluminum nitride (AlN), based on the total weight of nitrogen in the composition. In any of the embodiments, the composition may be substantially free of carbon.

### BRIEF DESCRIPTION OF THE DRAWINGS

FIG. 1 is a graph illustrating the effect of aluminum nitride content on the nitrogen level in the oxynitride glass, according to the examples.

FIG. 2 is a cross-section photograph of the oxynitride glass in Examples 1 and 4.

FIG. 3 is a graph illustrating the effect of nitrogen content on the hardness of the oxynitride glass in Examples 1 and 4.

### DETAILED DESCRIPTION

Various embodiments are described hereinafter. It should be noted that the specific embodiment are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiment and does not pose a limitation on the scope of the claims unless otherwise stated. No language in the specification should be construed as indicating any non-claimed element as essential.

As used herein, “substantially free” refers to less than about 2 wt %, less than about 1 wt %, less than about 0.5 wt %, less than about 0.1 wt %, or less than about 0.05 wt %, based on the total weight of the oxynitride glass. For example, the oxynitride glass may be substantially free of carbon. In any of the embodiments, the oxynitride glass may include less than about 10 atom % carbon (including less than about 5 atom %, less than 3 atom %, and less than 2 atom %), based on the total atoms in the oxynitride glass. In any of the embodiments, the oxynitride glass may include less than about 300 ppm carbon (including less than about 200 ppm, less than about 100 ppm, and less than about 50 ppm carbon). In any of the embodiments, the oxynitride glass may include no carbon. As used herein, “carbon” refers to carbon atoms in any form including elemental form, within a compound, or within a crystalline structure.

In any of the embodiments, the oxynitride glass may be substantially free of yettrium. In any of the embodiments, the oxynitride glass may include less than about 10 atom % yettrium (including less than about 5 atom %, less than 3 atom %, and less than 2 atom %), based on the total atoms in the oxynitride glass. In any of the embodiments, the oxynitride glass may include less than about 300 ppm yettrium (including less than about 200 ppm, less than about 100 ppm, and less than about 50 ppm yettrium). In any of the embodiments, the oxynitride glass may include no yettrium. As used herein, “yettrium” refers to yettrium atoms in any form including elemental form, ionic form, or within a crystalline structure.

As used herein “transparent” and “transparency” refers to a material's ability to allow light to pass through the material. A material's transparency may be defined by its percent light transmission. As used herein “percent light transmission” or “percent transmission” refers to the percent of light transmitted through the material. Percent transmission=I/Iₒ×100%, where I=0 is intensity of light entering the material and I is intensity of light leaving the material. If an object absorbs no light, I=Iₒ. In contrast, if a material absorbs the light completely, I=0 and percent transmission=0. In any of the embodiments, the some or all of the light allowed to pass through the material may be scattered (i.e., the material may not allow clear image formation). In any of the embodiments, the light allowed to pass through the material may not be scattered (i.e., the material may allow clear image formation).

Nitrogen content in the oxynitride glass described herein may be expressed in equivalent percentages (“e/o N” or “nitrogen equivalent percent”), because substituting nitrogen for oxygen on an equivalent charge basis enables cation ratios to be readily maintained (see S. Hampshire, R. A. L. Drew and K. H. Jack, Phys. Chem. Glasses, 26, 182-186 (1985) (herein incorporated by reference)). In any of the embodiments, the e/o N may be determined by EDS-SEM. In any of the embodiments, the oxynitride glass of the present technology may include up to about 24 e/o N. In any of the embodiments, the oxynitride glass may include up to about 23, 22, or 21 e/o N. In any of the embodiments, the oxynitride glass may include up to about 20 e/o N. In any of the embodiments, the oxynitride glass may include about 9 e/o N to about 24 e/o N. In any of the embodiments, the oxynitride glass may include about 10 e/o N to about 24 e/o N, about 10 e/o N to about 24 e/o N, about 12 e/o N to about 24 or about 22 e/o N, about 14 e/o N to about 24 or about 22 e/o N, about 15 e/o N to about 24 or about 22 e/o N, about 16 e/o N to about 24 or about 22 e/o N, about 17 e/o N to about 24 or about 22 e/o N, or about 18 e/o N to about 24 or about 22 e/o N.

In any of the embodiments, the oxynitride glass described herein may exhibit ballistic resistant. As used herein “ballistic resistant” or “ballistic resistance” refers to a material's ability to slow and/or stop a projectile. In any of the embodiments, the oxynitride glass described herein may exhibit at least ballistic resistance to a 17 grain, 0.22 caliber fragment simulating projectile (FSP) (according to MIL-P-46593A) traveling at 500 feet per second. In any of the embodiments, the oxynitride glass described herein may be ballistic resistant to a variety of projectiles. The projectiles may vary in size. In any of the embodiments, the projectile may have a diameter of at least about 0.5 cm. In any of the embodiments, the projectile may have a diameter of about 0.5 cm to about 30 cm. Nonlimiting examples of projectiles include bullets, shells, shrapnel, flying animals (e.g., bird), rock, shaped charged liners, and explosively formed penetrators.

In any of the embodiments, the oxynitride glass described herein may exhibit ductility during instrumented impact testing (i.e., no splintering during instrumented impact testing at 10 mph, 23° C., 10 lbs).

In any of the embodiments, the oxynitride glass described herein may exhibit chemical resistance. Techniques for measuring the chemical resistance of oxynitride glass are known in the art. For example, chemical resistance generally can be evaluated by observing any sign(s) of deterioration of the glass after exposing the glass to a chemical. In any of the embodiments, the oxynitride glass may exhibit excellent alkali chemical resistance (pH greater than 7.1). In any of the embodiments, the oxynitride glass may exhibit limited deterioration when exposed to a solution with a pH greater than about 8 for 2 hours. In any of the embodiments, the oxynitride glass may exhibit limited deterioration when exposed to a solution with a pH of about 8-14 (including 9-13 or 10-12) for 2 hours. In any of the embodiments, the oxynitride glass may pass ASTM C1203.

In any of the embodiments, the oxynitride glass described herein may exhibit scratch resistance. As used herein “scratch resistant” or “scratch resistance” refers to a material's hardness (i.e., its resistance to scratching). As used herein “hardness” may be described as Vickers hardness. To determine Vickers hardness, commonly the glass surface to be measured may be polished with 1 μm diamond paste followed by using a diamond indenter (100 g, 200 g, 500 g, 1000 g loads). The diagonal length of the indention can then measured using an optical microscope. The Vickers hardness can then be determined using Equation 1.

$$\text{Vickers Hardness (} \text{HV} \text{)} = 1.854 \frac{F}{{d}^{2}} \qquad ( 1 )$$

where, F: Test Load (kgf)
d: average indentation diagonal length (mm).

In any of the embodiments, the oxynitride glass may have a Vickers hardness of greater than or equal to about 6.5 GPa. In any of the embodiments, the oxynitride glass may have a Vickers hardness of about 7.5 GPa to about 19 GPa, about 8 GPa to about 18 GPa, about 9 GPa to about 16 GPa, or about 9 GPa to about 15 GPa.

It has surprisingly been discovered that an oxynitride glass with high hardness and/or scratch resistance can be produced and used in various applications at a much lower cost compared to presently available materials with high hardness and/or scratch resistance (e.g., sapphire and spinel). Commonly, the oxynitride glass exhibits a Vickers hardness of≥about 6.5 GPa. Preferably, the oxynitride glass may be transparent. Prior to the present technology, it was not possible to produce an oxynitride glass with transparency, high hardness, and/or scratch resistance.

The oxynitride glass in any of the embodiments may include aluminum, calcium, magnesium, silicon, oxygen, and nitrogen, wherein the aluminum may be provided by an aluminum source comprising about 1 wt % to about 100 wt % aluminum nitride (AlN), based on the total weight of aluminum in the oxynitride glass, and may be substantially free of carbon.

The oxynitride glass in any of the embodiments may include aluminum, calcium, magnesium, silicon, oxygen, and nitrogen, wherein the nitrogen may be provided by a nitrogen source comprising about 1 wt % to about 100 wt % aluminum nitride (AlN), based on the total weight of nitrogen in the oxynitride glass, and may be substantially free of carbon.

In any of the embodiments, the oxynitride glass provided herein may exhibit at least about 65% infrared light transmission (including the far infrared (15-1000 μm), the long wavelength infrared (8-14 μm), the mid-wavelength infrared (3-8 μm), and/or the near-infrared (0.75-1.4 μm)). In any of the embodiments, the oxynitride glass provided herein may exhibit at least about 65% infrared light transmission (including the long wavelength infrared (8-14 μm) and the mid-wavelength infrared (3-8 p.m)). In particular, the oxynitride glass provided herein may exhibit at least about 65% infrared light transmission (including the long wavelength infrared (8-14 μm) and the mid-wavelength infrared (3-5 μm)). In any of the embodiments, the oxynitride glass provided herein may exhibit at least about 70%, at least about 75%, at least about 80%, at least about 85%, at least about 90%, at least about 95%, or at least about 98% infrared light transmission. In any of the embodiments, the oxynitride glass provided herein may exhibit at least about 65% visible light transmission (380 nm-760 nm). In any of the embodiments, the oxynitride glass provided herein may exhibit at least about 70%, at least about 75%, at least about 80%, at least about 85%, at least about 90%, at least about 95%, or at least about 98% visible light transmission. In any of the embodiments, the oxynitride glass provided herein may exhibit infrared light transmission and visible light transmission. In any of the embodiments, the oxynitride glass provided herein may exhibit no more than about 50% visible light transmission. In any of the embodiments, the oxynitride glass provided herein may exhibit less than about 50%, less than about 45%, less than about 40%, less than about 35%, less than about 30%, less than about 25%, or less than about 20% visible light transmission. In any of the embodiments, the oxynitride glass provided herein may exhibit no more than about 50% UV light (10-400 nm) transmission. In any of the embodiments, the oxynitride glass provided herein may exhibit less than about 50%, less than about 45%, less than about 40%, less than about 35%, less than about 30%, less than about 25%, or less than about 20% UV light transmission.

In any of the embodiments, the oxynitride glass may include about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen. In any of the embodiments, the oxynitride glass may include about 5 to about 10 atom % aluminum, about 1 to about 3 atom % calcium, about 5 to about 10 atom % magnesium, about 20 to about 30 atom % silicon, about 50 to about 60 atom % oxygen, and 3 to 10 atom % nitrogen. In any of the embodiments, the oxynitride glass may include about 5.7 to about 6.6 atom % aluminum, about 1.4 to about 2 atom % calcium, about 6 to about 7 atom % magnesium, about 20 to about 30 atom % silicon, about 52 to about 68 atom % oxygen, and 5 to 8 atom % nitrogen. In any of the embodiments, the oxynitride glass may include about 6.1 to about 6.5 atom % aluminum, about 1.4 to about 1.8 atom % calcium, about 6.4 to about 6.8 atom % magnesium, about 20 to about 25 atom % silicon, about 52 to about 60 atom % oxygen, and 5 to 7 atom % nitrogen. In any of the embodiments, the oxynitride glass may include an atom % ratio of magnesium to calcium of about 5:1 to about 1:5 (including about 1:4-4:1, about 5:1-1:1, or about 5:1-3:1).

In any of the embodiments, the aluminum in the oxynitride glass may be provided by an aluminum source that includes about 1 wt % to about 100 wt % aluminum nitride (AlN), based on the total weight of aluminum in the oxynitride glass. In any of the embodiments, the aluminum source may include about 5 wt % to about 100 wt %, about 10 wt % to about 100 wt %, about 15 wt % to about 100 wt %, about 20 wt % to about 100 wt %, about 30 wt % to about 100 wt %, about 40 wt % to about 100 wt %, about 50 wt % to about 100 wt %, about 60 wt % to about 100 wt %, about 70 wt % to about 100 wt %, about 80 wt % to about 100 wt %, or about 90 wt % to about 100 wt % aluminum nitride (AlN), based on the total weight of aluminum in the oxynitride glass. In any of the embodiments, the aluminum source may include about 50 wt % to about 100 wt % aluminum nitride (AlN). In any of the embodiments, the aluminum source may include 0 wt % to about 99 wt % aluminum oxide (Al₂O₃), based on the total weight of aluminum in the oxynitride glass. In any of the embodiments, the aluminum source may include 0 wt % to about 75 wt %, 0 wt % to about 50 wt %, 0 wt % to about 25 wt %, or 0 wt % to about 20 wt % aluminum oxide (Al₂O₃), based on the total weight of aluminum in the oxynitride glass. In any of the embodiments, the aluminum source may include about 0.5 wt % to about 75 wt %, about 1 wt % to about 50 wt %, about 2 wt % to about 25 wt %, or about 3 wt % to about 20 wt % aluminum oxide (Al₂O₃), based on the total weight of aluminum in the oxynitride glass. In any of the embodiments, the aluminum source may include aluminum nitride (AlN) and aluminum oxide (Al₂O₃). In any of the embodiments, the aluminum source may consist of aluminum nitride (AlN).

In any of the embodiments, the silicon in the oxynitride glass may be provided by a silicon source that includes 1 wt % to about 100 wt % silicon oxide (SiO₂), based on the total weight of silicon in the oxynitride glass. In any of the embodiments, the silicon source may include about 50 wt % to about 100 wt %, about 60 wt % to about 100 wt %, about 70 wt % to about 100 wt %, or about 80 wt % to about 100 wt % silicon oxide (SiO₂), based on the total weight of silicon in the oxynitride glass. In any of the embodiments, the silicon source may include 0 wt % to about 100 wt % silicon nitride (Si₃N₄), based on the total weight of silicon in the oxynitride glass. In any of the embodiments, the silicon source may include 0 wt % to about 50 wt %, 0 wt % to about 40 wt %, 0 wt % to about 30 wt %, or 0 wt % to about 10 wt % silicon nitride (Si₃N₄), based on the total weight of silicon in the oxynitride glass. In any of the embodiments, the silicon source may include less than about 10 wt %, less than about 5 wt %, or less than about 2 wt % silicon nitride (Si₃N₄). In any of the embodiments, the silicon source may consist of silicon oxide (SiO₂). In any of the embodiments, the silicon source may include silicon oxide (SiO₂) and silicon nitride (Si₃N₄). In any of the embodiments, the silicon source may not include silicon nitride (Si₃N₄).

In any of the embodiments, the magnesium in the oxynitride glass may be provided by a magnesium source that includes 1 wt % to about 100 wt % magnesium oxide (MgO), based on the total weight of magnesium in the oxynitride glass. In any of the embodiments, the magnesium source may include about 50 wt % to about 100 wt %, about 60 wt % to about 100 wt %, about 70 wt % to about 100 wt %, or about 80 wt % to about 100 wt % magnesium oxide (MgO), based on the total weight of magnesium in the oxynitride glass. In any of the embodiments, the magnesium source may include 0 wt % to about 100 wt % magnesium nitride (Mg₃N₂), based on the total weight of magnesium in the oxynitride glass. In any of the embodiments, the magnesium source may include 0 wt % to about 50 wt %, 0 wt % to about 40 wt %, 0 wt % to about 30 wt %, or 0 wt % to about 10 wt % magnesium nitride (Mg₃N₂), based on the total weight of magnesium in the oxynitride glass. In any of the embodiments, the magnesium source may include 0 wt % to about 100 wt % magnesium hydride (MgH₂), based on the total weight of magnesium in the oxynitride glass. In any of the embodiments, the magnesium source may include 0 wt % to about 50 wt %, 0 wt % to about 40 wt %, 0 wt % to about 30 wt %, or 0 wt % to about 10 wt % magnesium hydride (MgH2), based on the total weight of magnesium in the oxynitride glass. In any of the embodiments, the magnesium source may consist of magnesium oxide (MgO). In any of the embodiments, the magnesium source may include magnesium oxide (MgO) and magnesium nitride (Mg₃N₂). In any of the embodiments, the magnesium source may include magnesium oxide (MgO), magnesium nitride (Mg₃N₂), magnesium hydride (MgH₂), or a combination of two or more thereof. In any of the embodiments, the magnesium source may not include magnesium carbonate (MgCO₃).

In any of the embodiments, the calcium in the oxynitride glass may be provided by a calcium source that includes 1 wt % to about 100 wt % calcium oxide (CaO), based on the total weight of calcium in the oxynitride glass. In any of the embodiments, the calcium source may include about 50 wt % to about 100 wt %, about 60 wt % to about 100 wt %, about 70 wt % to about 100 wt %, or about 80 wt % to about 100 wt % calcium oxide (CaO), based on the total weight of calcium in the oxynitride glass. In any of the embodiments, the calcium source may include 0 wt % to about 100 wt % calcium nitride (Ca₃N₂), based on the total weight of calcium in the oxynitride glass. In any of the embodiments, the calcium source may include 0 wt % to about 50 wt %, 0 wt % to about 40 wt %, 0 wt % to about 30 wt %, or 0 wt % to about 10 wt % calcium nitride (Ca₃N₂), based on the total weight of calcium in the oxynitride glass. In any of the embodiments, the calcium source may include 0 wt % to about 100 wt % calcium hydride (CaH₂), based on the total weight of calcium in the oxynitride glass. In any of the embodiments, the calcium source may include 0 wt % to about 50 wt %, 0 wt % to about 40 wt %, 0 wt % to about 30 wt %, or 0 wt % to about 10 wt % calcium hydride (CaH₂), based on the total weight of calcium in the oxynitride glass. In any of the embodiments, the calcium source may consist of calcium oxide (CaO). In any of the embodiments, the calcium source may include calcium oxide (CaO) and calcium nitride (Ca₃N₂). In any of the embodiments, the calcium source may include calcium oxide (CaO), calcium nitride (Ca₃N₂), calcium hydride (CaH₂), or a combination of two or more thereof. In any of the embodiments, the calcium source may not include calcium carbonate (CaCO₃).

In any of the embodiments, the nitrogen in the oxynitride glass may be provided by a nitrogen source that includes AlN, Si₃N₄, Mg₃N₂, Ca₃N_{2,} nitrogen gas, or a combination of two or more thereof. In any of the embodiments, the nitrogen in the oxynitride glass may be provided by a nitrogen source that includes AlN, Si₃N₄, nitrogen gas, or a combination of two or more thereof. In any of the embodiments, the nitrogen in the oxynitride glass may be provided by a nitrogen source that includes AlN, Mg₃N₂, Ca₃N₂, nitrogen gas, or a combination of two or more thereof. In any of the embodiments, the nitrogen in the oxynitride glass may be provided by a nitrogen source that includes AlN, nitrogen gas, or a combination thereof. In any of the embodiments, the nitrogen in the oxynitride glass may be provided by a nitrogen source that includes AlN. In any of the embodiments, the nitrogen source may include 1 wt % to about 100 wt % AlN, based on the total weight of nitrogen in the oxynitride glass. In any of the embodiments, the nitrogen source may include about 5 wt % to about 100 wt %, about 10 wt % to about 100 wt %, about 15 wt % to about 100 wt %, about 20 wt % to about 100 wt %, about 30 wt % to about 100 wt %, about 40 wt % to about 100 wt %, about 50 wt % to about 100 wt %, about 60 wt % to about 100 wt %, about 70 wt % to about 100 wt %, about 80 wt % to about 100 wt %, or about 90 wt % to about 100 wt % aluminum nitride (AlN), based on the total weight of nitrogen in the oxynitride glass. In any of the embodiments, the nitrogen source may include about 50 wt % to about 100 wt % aluminum nitride (AlN). In any of the embodiments, the nitrogen source may include 0 wt % to about 99 wt % nitrogen gas, based on the total weight of nitrogen in the oxynitride glass. In any of the embodiments, the nitrogen source may include 0 wt % to about 75 wt %, 0 wt % to about 50 wt %, 0 wt % to about 25 wt %, or 0 wt % to about 20 wt % nitrogen gas, based on the total weight of nitrogen in the oxynitride glass. In any of the embodiments, the nitrogen and the aluminum in the oxynitride glass may be provided by AlN.

In any of the embodiments, the oxygen in the oxynitride glass may be provided by an oxygen source that includes Al₂O₃, SiO₂, MgO, CaO, oxygen gas, or a combination of two or more thereof. In any of the embodiments, the oxygen in the oxynitride glass may be provided by an oxygen source that includes at least two of Al₂O₃, SiO₂, MgO, and CaO. In any of the embodiments, the oxygen in the oxynitride glass may be provided by an oxygen source that includes at least three of Al₂O₃, SiO₂, MgO, and CaO. In any of the embodiments, the oxygen in the oxynitride glass may be provided by an oxygen source that includes Al₂O₃, SiO₂, MgO, and CaO.

In any of the embodiments, the oxynitride glass may include about 40 wt % to about 80 wt % silicon oxide (SiO₂). In any of the embodiments, the oxynitride glass may include about 50 wt % to about 75 wt % silicon oxide (SiO₂) or about 60 wt % to about 70 wt % silicon oxide (SiO₂). In any of the embodiments, the oxynitride glass may include about 5 wt % to about 35 wt % aluminum oxide (Al₂O₃) and aluminum nitride (AlN) together. In any of the embodiments, the oxynitride glass may include about 6 wt % to about 25 wt % aluminum oxide (Al₂O₃) and aluminum nitride (AlN) together or about 8 wt % to about 15 wt % aluminum oxide (Al₂O₃) and aluminum nitride (AlN) together. In any of the embodiments, the oxynitride glass may include about 8 wt % to about 30 wt % calcium oxide (CaO) and magnesium oxide (MgO) together. In any of the embodiments, the oxynitride glass may include about 15 wt % to about 25 wt % calcium oxide (CaO) and magnesium oxide (MgO) together or about 20 wt % to about 25 wt % calcium oxide (CaO) and magnesium oxide (MgO) together. In any of the embodiments, the oxynitride glass may include about 40 wt % to about 80 wt % silicon oxide (SiO₂), about 5 wt % to about 35 wt % aluminum oxide (Al₂O₃) and aluminum nitride (AlN) together, and about 8 wt % to about 30 wt % calcium oxide (CaO) and magnesium oxide (MgO) together. In any of the embodiments, the oxynitride glass may include a wt % ratio of magnesium to calcium of about 5:1 to about 1:5 (including about 1:4-4:1, about 5:1-1:1, or about 5:1-3:1).

In any of the embodiments, the oxynitride glass may further include molybdenum (Mo), chromium (Cr), lanthanum (La), yttrium (Y), cerium (Ce), or a combination of two or more thereof. In any of the embodiments, the oxynitride glass may further include molybdenum (Mo), chromium (Cr), lanthanum (La), cerium (Ce), or a combination of two or more thereof. In any of the embodiments, the oxynitride glass may further include molybdenum (Mo). In any of the embodiments, the oxynitride glass may include any of the above listed elements in a range of about 100 ppm to about 500 ppm, based on the total mass of the oxynitride glass. In any of the embodiments, the oxynitride glass may include any of the above listed elements in a range of about 150 ppm to about 500 ppm, about 200 ppm to about 500 ppm, about 250 ppm to about 500 ppm, about 300 ppm to about 500 ppm, about 350 ppm to about 500 ppm, about 400 ppm to about 500 ppm, about 450 ppm to about 500 ppm, about 150 ppm to about 450 ppm, about 150 ppm to about 400 ppm, about 150 ppm to about 350 ppm, about 150 ppm to about 300 ppm, about 150 ppm to about 250 ppm, or about 150 ppm to about 200 ppm, based on the total mass of the oxynitride glass.

In another aspect, the present technology provides an oxynitride glass that may include about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen, wherein the aluminum is provided by an aluminum source comprising about 1 wt % to about 100 wt % aluminum nitride (AlN), based on the total weight of aluminum in the oxynitride glass and/or the nitrogen is provided by an aluminum source comprising about 1 wt % to about 100 wt % aluminum nitride (AlN), based on the total weight of nitrogen in the oxynitride glass; the silicon is provided by a silicon source comprising silicon oxide (SiO₂), the magnesium is provided by a magnesium source comprising magnesium oxide (MgO), the calcium is provided by a calcium source comprising calcium oxide (CaO), or a combination of two or more thereof. Preferably, the oxynitride glass may be substantially free of carbon, may exhibit a Vickers hardness of≥about 6.5 GPa, and/or may include about 9 e/o N to about 24 e/o N. In some embodiments, the oxynitride glass may exhibit at least about 65% infrared light transmission, at least about 65% visible light transmission, or a combination thereof. In some embodiments, the oxynitride glass may exhibit less than about 50% visible light transmission, at least about 65% infrared light transmission, or a combination thereof.

In another aspect, articles that include the oxynitride glass described herein are provided. The oxynitride glass may be in the form of glass fiber(s) and/or glass sheet(s). Preferably, the articles may exhibit scratch resistance and/or ballistic resistance. In any of the embodiments, the oxynitride glass may exhibit greater than 50% visible light transmission.

In any of the embodiments, the oxynitride glass may be in the form of a fiber (glass fiber). The glass fiber may be in any known dimension or shape for a glass fiber. The glass fiber may be produced by any known method including, but not limited to, the rotary process or the continuous filament process.

Glass sheets include, but are not limited to, windows, screens, optical lens (e.g., camera lens, magnifying glass, eye glasses/spectacles, microscope, projector, telescope, binoculars, dielectric lens, and the like), protective glasses, scanner glasses, or a combination of two or more thereof. In any of the embodiments, the oxynitride glass may have length of at least about 0.5 cm, a height of at least about 0.5 cm, and a width of at least about 0.2 cm. In any of the embodiments, the oxynitride glass may have length of 0.5 cm to about 160 cm, a height of about 0.5 cm to about 250 cm, and a width of about 0.2 cm to about 2.5 cm. In any of the embodiments, the oxynitride glass may have length of 0.5 cm to about 10 cm, a height of about 0.5 cm to about 10 cm, and a width of about 0.2 cm to about 1.5 cm. In any of the embodiments, the oxynitride glass may have length of 100 cm to about 160 cm, a height of about 150 cm to about 250 cm, and a width of about 1.0 cm to about 2.5 cm. In any of the embodiments, the oxynitride glass may have length of 20 cm to about 100 cm, a height of about 50 cm to about 150 cm, and a width of about 1.0 cm to about 2.5 cm.

In any of the embodiments, the article may be a personal electronic device (i.e., lightweight, electrically-powered equipment) that includes a glass sheet. Nonlimiting examples of personal electronic devices include smartphones, tablets, e-readers, laptops, watches including smartwatchs, MP3 players, and electronic toys. In any of the embodiments, the window, screen, optical lens, and/or protective glass may exhibit scratch resistance. In any of the embodiments, the oxynitride glass may exhibit greater than 50% visible light transmission.

In any of the embodiments, the article may include a window that includes a glass sheet. In any of the embodiments, the window may be an electromagnetic sensor window (EM sensor window).

In any of the embodiments, the article may include a window that includes a glass sheet. In any of the embodiments, the window may include an aircraft windscreen or a vehicle window. In any of the embodiments, the window may exhibit ballistic resistance. In any of the embodiments, the aircraft may be an armored aircraft and/or the vehicle may be an armored vehicle. In any of the embodiments, the oxynitride glass may exhibit greater than 50% visible light transmission.

In any of the embodiments, the article may include a protective glass that includes a glass sheet. The protective glass may be useful for a variety of applications. In any of the embodiments, the protective glass may be useful for uncommon applications for glass including, but not limit to, use in place of structural metal sheets, composite materials, and/or in combination with such materials. In any of the embodiments, the oxynitride glass may exhibit less than 50% visible light transmission.

In another aspect, a method is provided for making the oxynitride glass described herein. In any of the embodiments, the method may include mixing an aluminum source, calcium source, magnesium source, silicon source, nitrogen source, and oxygen source; heating the aluminum source, calcium source, magnesium source, silicon source, nitrogen source, and oxygen source to form a molten oxynitride glass; and cooling the molten oxynitride glass to provide the oxynitride glass. The oxynitride glass may include aluminum, calcium, magnesium, silicon, oxygen, and nitrogen. In any of the embodiments, the oxynitride glass may be substantially free of carbon.

The aluminum source, calcium source, magnesium source, silicon source, nitrogen source, and oxygen source may be any of the respective sources as described herein. In any of the embodiments, the aluminum source may include about 1 wt % to about 100 wt % aluminum nitride (AlN), based on the total weight of the aluminum source. In any of the embodiments, the nitrogen source may include about 1 wt % to about 100 wt % aluminum nitride (AlN), based on the total weight of the nitrogen source. The oxynitride glass may include any percent (weight, atomic, or mole percent) of the aluminum, calcium, magnesium, silicon, nitrogen, and oxygen as described herein. As described above, the oxynitride glass may further include molybdenum (Mo), chromium (Cr), lanthanum (La), yttrium (Y), cerium (Ce), or a combination of two or more thereof. The oxynitride glass may have the Vickers hardness as described above.

In any of the embodiments, the heating may be at a temperature of about 1500° C. to about 2000° C. (including about 1550° C. to about 1900° C. or about 1600° C. to about 1800° C.). In any of the embodiments, the heating may be at a positive pressure. In any of the embodiments, the heating may be at about 0.9 atm to about 1.2 atm (including standard pressure (i.e., 1 atm). In any of the embodiments, the heating may occur for about 20 minutes to 5 hours (including about 30 minutes to about 2 hours or about 45 minutes to about 75 minutes).

In any of the embodiments, the heating may occur in a gaseous environment. In any of the embodiments, the gaseous environment may include at least about 50% nitrogen (N2) gas. In any of the embodiments, the gaseous environment may include about 75% to about 100% nitrogen gas or about 90% to about 100% nitrogen gas. In any of the embodiments, the remainder of the gaseous environment may include one or more noble gases (i.e., He, Ne, Ar, Kr, Xe, Rn).

In any of the embodiments, the cooling may occur by annealing (i.e., slow cooling). In any of the embodiments, the cooling may occur by quenching (i.e., rapid cooling). In any of the embodiments, the process may further include heating and cooling the oxynitride glass one or more additional times.

In any of the embodiments, after mixing and prior to heating the aluminum source, calcium source, magnesium source, silicon source, nitrogen source, and/or oxygen source may be milled. In any of the embodiments, after cooling the process may further include shaping and/or trimming the oxynitride glass. In any of the embodiments, after cooling the process may further include grinding, milling, and/or polishing the oxynitride glass. In any of the embodiments, after cooling the oxynitride glass may be polished.

In any of the embodiments, the aluminum source, calcium source, magnesium source, silicon source, nitrogen source, and oxygen source may be in a crucible during the heating. The crucible may include molybdenum (Mo), tantalum (Ta), niobium (Nb), tungsten (W), nickel (Ni), or a combination of two or more thereof. In any of the embodiments, the crucible may include molybdenum (Mo). In any of the embodiments, the crucible may not include tungsten, graphite, niobium, platinum crucible, or a combination of two or more thereof. In any of the embodiments, the crucible may not be coated with boron nitride.

In any of the embodiments, the heating may occur in any furnace/oven able to achieve the necessary temperatures and pressures as well as maintain the appropriate gaseous environment. For example, to maintain the appropriate gaseous environment the furnace/oven may have a hermetic seal or be able to accept a muffle tube with a hermitic seal. In any of the embodiments, the heating may occur in a metal hot zone furnace/oven. The furnace/oven may include any heating element able to achieve the necessary temperature. Nonlimiting heating element examples include tungsten, molybdenum, moly disilicide, and the like.

In some other aspects, a composition may be provided that includes an aluminum source, a calcium source, a magnesium source, a silicon source, a nitrogen source, and oxygen source. In any of the embodiments, the aluminum source may include about 1 wt % to about 100 wt % aluminum nitride (AlN), based on the total weight of the aluminum source. In any of the embodiments, the nitrogen source may include about 1 wt % to about 100 wt % aluminum nitride (AlN), based on the total weight of the nitrogen source. In any of the embodiments, the composition may be substantially free of carbon.

In any of the embodiments, the composition may include about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen. In any of the embodiments, the composition may include about 5 to about 10 atom % aluminum, about 1 to about 3 atom % calcium, about 5 to about 10 atom % magnesium, about 20 to about 30 atom % silicon, about 50 to about 60 atom % oxygen, and 3 to 10 atom % nitrogen. In any of the embodiments, the composition may include about 5.7 to about 6.6 atom % aluminum, about 1.4 to about 2 atom % calcium, about 6 to about 7 atom % magnesium, about 20 to about 30 atom % silicon, about 52 to about 68 atom % oxygen, and 5 to 8 atom % nitrogen. In any of the embodiments, the composition may include about 6.1 to about 6.5 atom % aluminum, about 1.4 to about 1.8 atom % calcium, about 6.4 to about 6.8 atom % magnesium, about 20 to about 25 atom % silicon, about 52 to about 60 atom % oxygen, and 5 to 7 atom % nitrogen.

The aluminum source, calcium source, magnesium source, silicon source, nitrogen source, and oxygen source may be any of the respective sources as described herein. The composition may include any percent (weight, atomic, or mole percent) of the aluminum, calcium, magnesium, silicon, nitrogen, and oxygen as described herein.

### EXAMPLES

### Example 1

### Oxynitride Glass with Aluminum Nitride and No Aluminum Oxide Heated in a Molybdenum Crucible

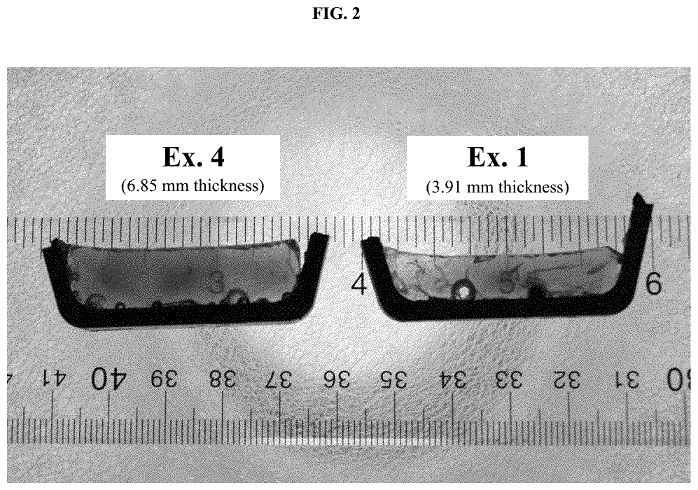

The raw materials silicon oxide (60.9 wt %), aluminum nitride (17.4 wt), calcium oxide (5.6 wt %), and magnesium oxide (16.2 wt %) were mixed and placed in a molybdenum crucible. The crucible was heated to 1675° C. for one hour in a metal hot zone furnace (tungsten heating elements) in a 100% nitrogen gas environment to produce a glass melt. The crucible was allowed to cool to room temperature. The resulting oxynitride glass was transparent, had few inclusions and defects, did not exhibit any significant reaction layer at the crucible-melt interface, and was un-cracked (see FIG. 2).

### Examples 2-7

### Oxynitride Glasses with Varying Amounts of Aluminum Nitride (AlN) Heated in a Molybdenum Crucible

Example oxynitride glasses 2-7 were prepared following the same protocol as Example 1 using the raw materials provided in Table 1. The resulting oxynitride glasses were transparent, had few inclusions and defects, did not exhibit any significant reaction layer at the crucible-melt interface, and were un-cracked.

TABLE 1
weight percent of raw materials

| component | Ex. 1 | Ex. 2 | Ex. 3 | Ex. 4 | Ex. 5 | Ex. 6 | Ex. 7 |
|---|---|---|---|---|---|---|---|
| SiO₂ (wt %) | 56.0 | 55.6 | 55.1 | 54.7 | 54.3 | 53.9 | 53.7 |
| AlN (wt %) | 17.0 | 14.2 | 11.4 | 8.5 | 5.7 | 2.9 | 0.0 |
| Al₂O₃ (wt %) | 0.0 | 3.4 | 6.8 | 10.2 | 13.5 | 16.9 | 20.3 |
| CaO (wt %) | 7.0 | 7.0 | 7.0 | 7.0 | 7.0 | 7.0 | 6.7 |
| MgO (wt %) | 20.0 | 19.9 | 19.8 | 19.6 | 19.5 | 19.4 | 19.2 |

### Example 8

### Oxynitride Glass with Aluminum Nitride and No Aluminum Oxide Heated in a Graphite Crucible

Example oxynitride glass 8 was prepared following the same protocol as Example 1 except a graphite crucible was used in place of the molybdenum crucible. The resulting oxynitride glass had carbon inclusions, metal pockets (likely due to carbon-thermal reduction of the raw components), and was opaque with extensive cracking of the glass melt on cooling.

### Examples 9

### Oxynitride Glass with Aluminum Nitride and No Aluminum Oxide Heated in a Niobium Crucible

Example oxynitride glass 9 was prepared following the same protocol as Example 1 except a niobium crucible was used in place of the molybdenum crucible. The resulting oxynitride glass had formation of a niobium nitride layer at the crucible interface, incorporation of small amounts of niobium in the melt, incomplete melted or reacted raw materials, and extensive cracking of the glass melt on cooling.

### Examples 10

### Oxynitride Glass with Aluminum Nitride and No Aluminum Oxide Heated in a Tungsten Crucible

Example oxynitride glass 10 was prepared following the same protocol as Example 1 except a tungsten crucible was used in place of the molybdenum crucible. The resulting oxynitride glass had a reaction at the glass-crucible interface and extensive cracking of the glass melt on cooling.

### Examples 11

### Oxynitride Glass Examples 1-7 Nitrogen Levels

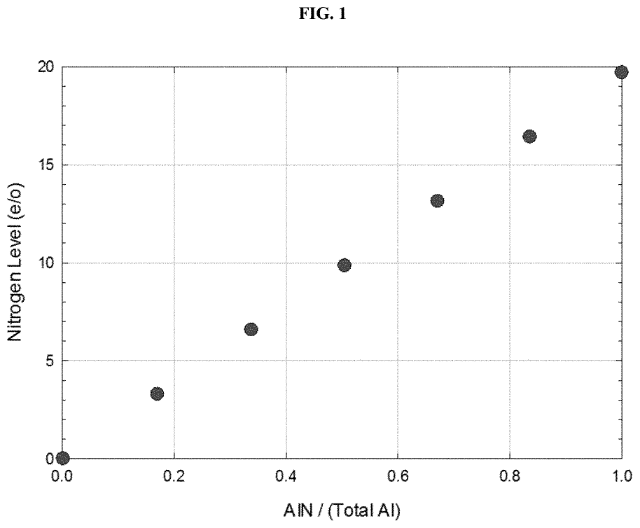

The nitrogen levels (e/o N) of glass Examples 1-7 were determined using energy dispersive spectroscopy via scanning electron microscope (EDS-SEM). As demonstrated in Table 2 and FIG. 1, as the percent of aluminum nitride based on the total amount of aluminum source increased, the nitrogen level in the oxynitride glass increased. As illustrated in FIG. 2, the higher nitrogen content oxynitride glass (Example 1) had greater transparency (e.g., visible light) than the lower nitrogen content oxynitride glass (Example 4) indicating transparency may increase as the nitrogen content in the oxynitride glass increases.

TABLE 2
Nitrogen Level in Oxynitride Glasses for Examples 1-7

| | Ex. 1 | Ex. 2 | Ex. 3 | Ex. 4 | Ex. 5 | Ex. 6 | Ex. 7 |
|---|---|---|---|---|---|---|---|
| Nitrogen Level | 19.7 | 16.4 | 13.1 | 9.8 | 6.6 | 3.3 | 0 |
| (e/o N) | | | | | | | |

### Examples 12

### Hardness of Oxynitride Glass Examples 1 and 4

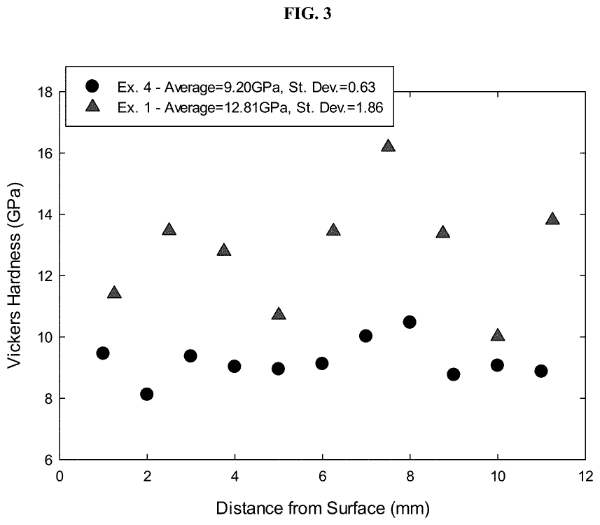

The Vickers hardness of glass Examples 1 and 4 were determined. As demonstrated in FIG. 3, glass Example 1 had a greater hardness (Vickers hardness average of 12.81 GPa) compared to glass Example 4 (Vickers hardness average of 9.20 GPa).

As demonstrated by Examples 1-12, as the percent of aluminum nitride (based on the total amount of aluminum and/or nitrogen source) increases, the transparency, nitrogen level, and hardness of the oxynitride glass also increase. Prior to the present technology, silicon nitride (Si3N4) was commonly used to incorporate silicon and nitrogen into an oxynitride glass. Surprisingly, it was discovered that aluminum nitride is a much better material for incorporating nitrogen into an oxynitride glass compared to silicon nitride likely due to aluminum nitrides ability to readily dissolve in the melt. Not wishing to be bound by theory, it is speculated that the aluminum content (and therefore the AlN content) is limited by the overall glass formation chemistry, which may be affected by other elements in the glass (e.g., calcium and/or magnesium). Additionally, forming the melt in a nitrogen gas rich environment (i.e., at least 50% nitrogen gas) may also contribute to the nitrogen levels in the oxynitride glass. It has also been discovered that limiting the carbon presence (e.g., source material, crucible, and/or gaseous environment during melt formation) in the oxynitride glass may contribute to increased transparency, fewer inclusions and defects, and/or reduced cracking of the glass melt on cooling.

### ILLUSTRATIVE EMBODIMENTS

Reference is made in the following to a number of illustrative embodiments of the subject matter described herein. The following embodiments describe illustrative embodiments that may include various features, characteristics, and advantages of the subject matter as presently described. Accordingly, the following embodiments should not be considered as being comprehensive of all of the possible embodiments or otherwise limit the scope of the compositions described herein.

Paragraph 1. An oxynitride glass comprising aluminum, calcium, magnesium, silicon, oxygen, and nitrogen, wherein the aluminum may be provided by an aluminum source comprising about 1 wt % to about 100 wt % aluminum nitride (AlN) based on the total weight of aluminum in the oxynitride glass. The oxynitride glass may be transparent. The oxynitride glass may be substantially free of carbon.

Paragraph 2. The oxynitride glass of paragraph 1, wherein the oxynitride glass comprises about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen.

Paragraph 3. The oxynitride glass of paragraph 1 or 2, wherein the aluminum may be provided by an aluminum source comprising by 0 to about 99 wt % aluminum oxide (Al2O₃) based on the total weight of aluminum in the oxynitride glass.

Paragraph 4. The oxynitride glass of any one of paragraphs 1-3, wherein the aluminum may be provided by an aluminum source comprising about 50 wt % to about 100 wt % aluminum nitride (AlN) based on the total weight of aluminum in the oxynitride glass.

Paragraph 5. The oxynitride glass of any one of paragraphs 1-4, wherein the silicon may be provided by a silicon source comprising silicon oxide (SiO₂).

Paragraph 6. The oxynitride glass of any one of paragraphs 1-5, wherein the magnesium may be provided by a magnesium source comprising magnesium oxide (MgO).

Paragraph 7. The oxynitride glass of any one of paragraphs 1-6, wherein the calcium may be provided by a calcium source comprising calcium oxide (CaO).

Paragraph 8. The oxynitride glass of any one of paragraphs 1-7, wherein the oxynitride glass comprises up to about 24 e/o N.

Paragraph 9. The oxynitride glass of any one of paragraphs 1-8, wherein the oxynitride glass comprises about 9 e/o N to about 24 e/o N.

Paragraph 10. The oxynitride glass of any one of paragraphs 1-9, wherein the oxynitride glass further comprises molybdenum (Mo), chromium (Cr), lanthanum (La), yttrium (Y), cerium (Ce), or a combination of two or more thereof.

Paragraph 11. The oxynitride glass of any one of paragraphs 1-10, wherein the oxynitride glass exhibits a Vickers hardness of≥about 6.5 GPa.

Paragraph 12. The oxynitride glass of any one of paragraphs 1-11, wherein the oxynitride glass exhibits a Vickers hardness of about 7.5 GPa to about 19 GPa.

Paragraph 13. The oxynitride glass of any one of paragraphs 1-12, wherein the oxynitride glass exhibits a Vickers hardness of about 8 GPa to about 18 GPa.

Paragraph 14. The oxynitride glass of any one of paragraphs 1-13, wherein the oxynitride glass exhibits at least about 65% infrared light transmission, at least about 65% visible light transmission, or a combination thereof.

Paragraph 15. The oxynitride glass of any one of paragraphs 1-13, wherein the oxynitride glass exhibits less than about 50% visible light transmission.

Paragraph 16. The oxynitride glass of paragraph 15, wherein the oxynitride glass exhibits at least about 65% infrared light transmission.

Paragraph 17. The oxynitride glass of paragraph 14 or paragraph 16, wherein the infrared light transmission comprises wavelengths of about 3 μm to about 5 μm and/or about 8 μm to about 14 μm.

Paragraph 18. An article comprising the oxynitride glass of any one of paragraphs 1-17.

Paragraph 19. The article of paragraph 18, wherein the article comprises a window, screen, optical lens, protective glass, scanner glass, glass fiber, or a combination of two or more thereof.

Paragraph 20. The article of paragraph 19, wherein the window comprises an aircraft windscreen.

Paragraph 21. The article of paragraph 19 or 20, wherein the window may be ballistic resistant.

Paragraph 22. A method for making an oxynitride glass, the method comprising: mixing an aluminum source, calcium source, magnesium source, silicon source, nitrogen source, and oxygen source; heating the aluminum source, calcium source, magnesium source, silicon source, nitrogen source, and oxygen source to form a molten oxynitride glass; cooling the molten oxynitride glass; wherein: the oxynitride glass comprises aluminum, calcium, magnesium, silicon, oxygen, and nitrogen; and the aluminum source comprises about 1 wt % to about 100 wt % aluminum nitride (AlN) based on the total weight of the aluminum source. The oxynitride glass may be transparent. The oxynitride glass may be substantially free of carbon.

Paragraph 23. The method of paragraph 22, wherein the heating may be at a temperature of about 1500° C. to about 2000° C.

Paragraph 24. The method of paragraph 22 or 23, wherein the heating may be at about 0.9 atm to about 1.2 atm.

Paragraph 25. The method of any one of paragraphs 22-24, wherein the heating may be in a gaseous environment comprising at least about 50% nitrogen gas.

Paragraph 26. The method of paragraph 25, wherein the gaseous environment comprises about 75% to about 100% nitrogen gas.

Paragraph 27. The method of paragraph 25 or 26, wherein the gaseous environment comprises about 90% to about 100% nitrogen gas.

Paragraph 28. The method of any one of paragraphs 22-27, wherein the aluminum source, calcium source, magnesium source, silicon source, nitrogen source, and oxygen source may be in a crucible during the heating, wherein the crucible comprises molybdenum (Mo), tantalum (Ta),niobium (Nb), tungsten (W), nickel (Ni), or a combination of two or more thereof.

Paragraph 29. The method of any one of paragraphs 22-28, wherein the oxynitride glass comprises about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen.

Paragraph 30. The method of any one of paragraphs 22-29, wherein the aluminum source comprises 0 to about 99 wt % aluminum oxide (Al₂O₃) based on the total weight of the aluminum source.

Paragraph 31. The method of any one of paragraphs 22-30, wherein the silicon source comprises silicon oxide (SiO₂).

Paragraph 32. The method of any one of paragraphs 22-31, wherein the silicon source does not comprise silicon nitride (Si₃N₄).

Paragraph 33. The method of any one of paragraphs 22-32, wherein the magnesium source comprises magnesium oxide (MgO).

Paragraph 34. The method of any one of paragraphs 22-33, wherein the calcium source comprises calcium oxide (CaO).

Paragraph 35. The method of any one of paragraphs 22-34, wherein the oxynitride glass comprises up to about 24 e/o N.

Paragraph 36. The method of any one of paragraphs 22-35, wherein the oxynitride glass further comprises molybdenum (Mo), chromium (Cr), lanthanum (La), yttrium (Y), cerium (Ce), or a combination of two or more thereof.

Paragraph 37. The method of any one of paragraphs 22-36, wherein the oxynitride glass exhibits a Vickers hardness of≥about 6.5 GPa.

Paragraph 38. A composition comprising an aluminum source, a calcium source, a magnesium source, a silicon source, a nitrogen source, and an oxygen source, wherein the aluminum source comprises about 1 wt % to about 100 wt % aluminum nitride (AlN) based on the total weight of aluminum in the composition. The composition may be substantially free of carbon.

Paragraph 39. The composition of paragraph 38, wherein the composition comprises about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen.

Paragraph 40. The composition of paragraph 38 or 39, wherein the aluminum source comprises 0 to about 99 wt % aluminum oxide (Al₂O₃), based on the total weight of the aluminum source.

Paragraph 41. The composition of any one of paragraphs 38-40, wherein the silicon source comprises silicon oxide (SiO₂).

Paragraph 42. The composition of any one of paragraphs 38-41, wherein the silicon source does not comprise silicon nitride (Si₃N₄).

Paragraph 43. The composition of any one of paragraphs 38-42, wherein the magnesium source comprises magnesium oxide (MgO).

Paragraph 44. The composition of any one of paragraphs 38-43, wherein the calcium source comprises calcium oxide (CaO).

Paragraph 45. An oxynitride glass comprising aluminum, calcium, magnesium, silicon, oxygen, and nitrogen, wherein the nitrogen may be provided by a nitrogen source comprising about 1 wt % to about 100 wt % aluminum nitride (AlN) based on the total weight of nitrogen in the oxynitride glass. The oxynitride glass may be transparent. The oxynitride glass may be substantially free of carbon.

Paragraph 46. The oxynitride glass of paragraph 45, wherein the oxynitride glass comprises about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen.

Paragraph 47. The oxynitride glass of paragraph 45 or 46, wherein the aluminum may be provided by an aluminum source comprising the about 1 wt % to about 100 wt % aluminum nitride (AlN).

Paragraph 48. The oxynitride glass of paragraph 45-47, wherein the aluminum may be provided by an aluminum source comprising by 0 to about 99 wt % aluminum oxide (Al₂O₃) based on the total weight of aluminum in the oxynitride glass.

Paragraph 49. The oxynitride glass of any one of paragraphs 45-48, wherein the aluminum may be provided by an aluminum source comprising about 50 wt % to about 100 wt % aluminum nitride (AlN) based on the total weight of aluminum in the oxynitride glass.

Paragraph 50. The oxynitride glass of any one of paragraphs 45-49, wherein the silicon may be provided by a silicon source comprising silicon oxide (SiO₂).

Paragraph 51. The oxynitride glass of any one of paragraphs 45-50, wherein the magnesium may be provided by a magnesium source comprising magnesium oxide (MgO).

Paragraph 52. The oxynitride glass of any one of paragraphs 45-51, wherein the calcium may be provided by a calcium source comprising calcium oxide (CaO).

Paragraph 53. The oxynitride glass of any one of paragraphs 45-52, wherein the oxynitride glass comprises up to about 24 e/o N.

Paragraph 54. The oxynitride glass of any one of paragraphs 45-53, wherein the oxynitride glass comprises about 9 e/o N to about 24 e/o N.

Paragraph 55. The oxynitride glass of any one of paragraphs 45-54, wherein the oxynitride glass further comprises molybdenum (Mo), chromium (Cr), lanthanum (La), yttrium (Y), cerium (Ce), or a combination of two or more thereof.

Paragraph 56. The oxynitride glass of any one of paragraphs 45-55, wherein the oxynitride glass exhibits a Vickers hardness of≥about 6.5 GPa.

Paragraph 57. The oxynitride glass of any one of paragraphs 45-56, wherein the oxynitride glass exhibits a Vickers hardness of about 7.5 GPa to about 19 GPa.

Paragraph 58. The oxynitride glass of any one of paragraphs 45-57, wherein the oxynitride glass exhibits a Vickers hardness of about 8 GPa to about 18 GPa.

Paragraph 59. The oxynitride glass of any one of paragraphs 45-58, wherein the oxynitride glass exhibits at least about 65% infrared light transmission, at least about 65% visible light transmission, or a combination thereof.

Paragraph 60. The oxynitride glass of any one of paragraphs 45-58, wherein the oxynitride glass exhibits less than about 50% visible light transmission.

Paragraph 61. The oxynitride glass of paragraph 60, wherein the oxynitride glass exhibits at least about 65% infrared light transmission.

Paragraph 62. The oxynitride glass of paragraph 59 or paragraph 61, wherein the infrared light transmission comprises wavelengths of about 3 um to about 5 um and/or about 8 um to about 14 um.

Paragraph 63. An article comprising the oxynitride glass of any one of paragraphs 45-62.

Paragraph 64. The article of paragraph 63, wherein the article comprises a window, screen, optical lens, protective glass, scanner glass, glass fiber, or a combination of two or more thereof.

Paragraph 65. The article of paragraph 64, wherein the window comprises an aircraft windscreen.

Paragraph 66. The article of paragraph 64 or 65, wherein the window may be ballistic resistant.

Paragraph 67. A method for making an oxynitride glass, the method comprising: mixing an aluminum source, calcium source, magnesium source, silicon source, nitrogen source, and oxygen source; heating the aluminum source, calcium source, magnesium source, silicon source, nitrogen source, and oxygen source to form a molten oxynitride glass; cooling the molten oxynitride glass; wherein: the oxynitride glass comprises aluminum, calcium, magnesium, silicon, oxygen, and nitrogen; and the nitrogen source comprises about 1 wt % to about 100 wt % aluminum nitride (AlN) based on the total weight of the nitrogen source. The oxynitride glass may be transparent. The oxynitride glass may be substantially free of carbon.

Paragraph 68. The method of paragraph 67, wherein the heating may be at a temperature of about 1500° C. to about 2000° C.

Paragraph 69. The method of paragraph 67 or 68, wherein the heating may be at about 0.9 atm to about 1.2 atm.

Paragraph 70. The method of any one of paragraphs 67-69, wherein the heating may be in a gaseous environment comprising at least about 50% nitrogen gas.

Paragraph 71. The method of paragraph 70, wherein the gaseous environment comprises about 75% to about 100% nitrogen gas.

Paragraph 72. The method of paragraph 70 or 71, wherein the gaseous environment comprises about 90% to about 100% nitrogen gas.

Paragraph 73. The method of any one of paragraphs 67-72, wherein the aluminum source, calcium source, magnesium source, silicon source, nitrogen source, and oxygen source may be in a crucible during the heating, wherein the crucible comprises molybdenum (Mo), tantalum (Ta),niobium (Nb), tungsten (W), nickel (Ni), or a combination of two or more thereof.

Paragraph 74. The method of any one of paragraphs 67-73, wherein the oxynitride glass comprises about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen.

Paragraph 75. The method of any one of paragraphs 67-74, wherein the aluminum may be provided by an aluminum source comprising the about 1 wt % to about 100 wt % aluminum nitride (AlN).

Paragraph 76. The method of any one of paragraphs 67-75, wherein the aluminum source comprises 0 to about 99 wt % aluminum oxide (Al₂O₃) based on the total weight of the aluminum source.

Paragraph 77. The method of any one of paragraphs 67-76, wherein the silicon source comprises silicon oxide (SiO₂).

Paragraph 78. The method of any one of paragraphs 67-77, wherein the silicon source does not comprise silicon nitride (Si3N4).

Paragraph 79. The method of any one of paragraphs 67-78, wherein the magnesium source comprises magnesium oxide (MgO).

Paragraph 80. The method of any one of paragraphs 67-79, wherein the calcium source comprises calcium oxide (CaO).

Paragraph 81. The method of any one of paragraphs 67-80, wherein the oxynitride glass comprises up to about 24 e/o N.

Paragraph 82. The method of any one of paragraphs 67-81, wherein the oxynitride glass further comprises molybdenum (Mo), chromium (Cr), lanthanum (La), yttrium (Y), cerium (Ce), or a combination of two or more thereof.

Paragraph 83. The method of any one of paragraphs 67-82, wherein the oxynitride glass exhibits a Vickers hardness of≥about 6.5 GPa.

Paragraph 84. A composition comprising an aluminum source, a calcium source, a magnesium source, a silicon source, a nitrogen source, and an oxygen source, wherein the nitrogen source comprises about 1 wt % to about 100 wt % aluminum nitride (AlN) based on the total weight of nitrogen in the composition. The composition may be substantially free of carbon.

Paragraph 85. The composition of paragraph 84, wherein the composition comprises about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen.

Paragraph 86. The composition of paragraph 84 or paragraph 85, wherein the aluminum may be provided by an aluminum source comprising the about 1 wt % to about 100 wt % aluminum nitride (AlN).

Paragraph 87. The composition of any one of paragraphs 84-86, wherein the aluminum source comprises 0 to about 99 wt % aluminum oxide (Al₂O₃), based on the total weight of the aluminum source.

Paragraph 88. The composition of any one of paragraphs 84-87, wherein the silicon source comprises silicon oxide (SiO₂).

Paragraph 89. The composition of any one of paragraphs 84-88, wherein the silicon source does not comprise silicon nitride (Si₃N₄).

Paragraph 90. The composition of any one of paragraphs 84-89, wherein the magnesium source comprises magnesium oxide (MgO).

Paragraph 91. The composition of any one of paragraphs 84-90, wherein the calcium source comprises calcium oxide (CaO).

While certain embodiment have been illustrated and described, it should be understood that changes and modifications can be made therein in accordance with ordinary skill in the art without departing from the technology in its broader aspects as defined in the following claims.

The embodiment, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiment described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiment only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiment are set forth in the following claims.

What is claimed is:

1. A transparent oxynitride glass comprising aluminum, calcium, magnesium, silicon, oxygen, and nitrogen, wherein the aluminum is provided by an aluminum source comprising about 1 wt % to about 100 wt % aluminum nitride (AlN), based on the total weight of aluminum in the oxynitride glass; with the proviso that the oxynitride glass is substantially free of carbon.

2. The oxynitride glass of claim 1, wherein the oxynitride glass comprises about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen.

3. The oxynitride glass of claim 1, wherein the aluminum is provided by an aluminum source comprising by 0 to about 99 wt % aluminum oxide (Al₂O₃) based on the total weight of aluminum in the oxynitride glass.

4. The oxynitride glass of claim 1, wherein the aluminum is provided by an aluminum source comprising about 50 wt % to about 100 wt % aluminum nitride (AlN) based on the total weight of aluminum in the oxynitride glass.

5. The oxynitride glass of claim 1, wherein the silicon is provided by a silicon source comprising silicon oxide (SiO₂), the magnesium is provided by a magnesium source comprising magnesium oxide (MgO), the calcium is provided by a calcium source comprising calcium oxide (CaO), or a combination of two or more thereof.

6. The oxynitride glass of claim 1, wherein the oxynitride glass comprises up to about 24 e/o N.

7. The oxynitride glass of claim 1, wherein the oxynitride glass comprises about 9 e/o N to about 24 e/o N.

8. The oxynitride glass of claim 1, wherein the oxynitride glass further comprises molybdenum (Mo), chromium (Cr), lanthanum (La), yttrium (Y), cerium (Ce), or a combination of two or more thereof.

9. The oxynitride glass of claim 1, wherein the oxynitride glass exhibits a Vickers hardness of≥about 6.5 GPa.

10. The oxynitride glass of claim 9, wherein the oxynitride glass exhibits a Vickers hardness of about 7.5 GPa to about 19 GPa.

11. The oxynitride glass of claim 1, wherein the oxynitride glass exhibits at least about 65% infrared light transmission, at least about 65% visible light transmission, or a combination thereof.

12. The oxynitride glass of claim 1, wherein the oxynitride glass exhibits less than about 50% visible light transmission.

13. The oxynitride glass of claim 12, wherein the oxynitride glass exhibits at least about 65% infrared light transmission.

14. An article comprising the oxynitride glass of claim 1.

15. The article of claim 14, wherein the article comprises a window, screen, optical lens, protective glass, scanner glass, glass fiber, or a combination of two or more thereof.

16. A method for making a transparent oxynitride glass, the method comprising:
mixing an aluminum source, calcium source, magnesium source, silicon source, nitrogen source, and oxygen source;
heating the aluminum source, calcium source, magnesium source, silicon source, nitrogen source, and oxygen source to form a molten oxynitride glass;
cooling the molten oxynitride glass;
wherein:
the oxynitride glass comprises aluminum, calcium, magnesium, silicon, oxygen, and nitrogen from the aluminum source, calcium source, magnesium source, silicon source, nitrogen source, and oxygen source; and
the aluminum source comprises about 1 wt % to about 100 wt % aluminum nitride (AlN) based on the total weight of the aluminum source;
with the proviso that the oxynitride glass is substantially free of carbon.

17. The method of claim 16, wherein the aluminum source, calcium source, magnesium source, silicon source, nitrogen source, and oxygen source are in a crucible during the heating, wherein the crucible comprises molybdenum (Mo), tantalum (Ta),niobium (Nb), tungsten (W), nickel (Ni), or a combination of two or more thereof.

18. The method of claim 16, wherein the oxynitride glass comprises about 3 to about 10 atom % aluminum, about 0.5 to about 5 atom % calcium, about 3 to about 10 atom % magnesium, about 15 to about 35 atom % silicon, about 45 to about 70 atom % oxygen, and about 0.5 to about 12 atom % nitrogen.

19. The method of claim 16, wherein the silicon source does not comprise silicon nitride (Si₃N₄).

20. A composition comprising an aluminum source, a calcium source, a magnesium source, a silicon source, a nitrogen source, and an oxygen source, wherein the aluminum source comprises about 1 wt % to about 100 wt % aluminum nitride (AlN) based on the total weight of aluminum in the composition; with the proviso that the composition is substantially free of carbon.

21. A transparent oxynitride glass comprising aluminum, calcium, magnesium, silicon, oxygen, and nitrogen, wherein the nitrogen is provided by a nitrogen source comprising about 1 wt % to about 100 wt % aluminum nitride (AlN) based on the total weight of nitrogen in the oxynitride glass; with the proviso that the oxynitride glass is substantially free of carbon.

22. An article comprising the oxynitride glass of claim 21.

23. A method for making a transparent oxynitride glass, the method comprising:
mixing an aluminum source, calcium source, magnesium source, silicon source, nitrogen source, and oxygen source;
heating the aluminum source, calcium source, magnesium source, silicon source, nitrogen source, and oxygen source to form a molten oxynitride glass;
cooling the molten oxynitride glass;
wherein:
the oxynitride glass comprises aluminum, calcium, magnesium, silicon, oxygen, and nitrogen from the aluminum source, calcium source, magnesium source, silicon source, nitrogen source, and oxygen source; and
the nitrogen source comprises about 1 wt % to about 100 wt % aluminum nitride (AlN) based on the total weight of the nitrogen source;
with the proviso that the oxynitride glass is substantially free of carbon.
